(19) United States
(12) Patent Application Publication
(10) Pub. No.: US 2023/0167901 A1
(43) Pub. Date: Jun. 1, 2023

(54) FUNCTIONAL ELEMENT WITH FILTER PORTION

(71) Applicants: Tomas Pupsys, Southfield, MI (US); Kirk Eidam, Bad Camberg (DE); Thomas Anhorn, Dettingen (DE)

(72) Inventors: Tomas Pupsys, Southfield, MI (US); Kirk Eidam, Bad Camberg (DE); Thomas Anhorn, Dettingen (DE)

(73) Assignees: ElringKlinger AG, Dettingen (DE); ElringKlinger Automotive Manufacturing, Inc., Southfield, MI (US)

(21) Appl. No.: 18/160,122

(22) Filed: Jan. 26, 2023

Related U.S. Application Data
(63) Continuation of application No. PCT/EP2021/071012, filed on Jul. 27, 2021.
(60) Provisional application No. 63/058,396, filed on Jul. 29, 2020.

(51) Int. Cl. F16J 15/08; F16J 15/12

(52) U.S. Cl. CPC F16J 15/0825; F16J 15/122

(57) ABSTRACT

A functional element is provided which comprises a functional layer with at least one filter portion, a covering part on each side of the functional layer, at least one fluid passage in the functional element which passes through a passage area of the at least one filter portion, and a sealing segment which surrounds the passage area in a circumferentially closed manner with sealing material of the sealing segment permeating the filter portion to provide a seal in the filter portion and between the covering parts and the filter portion.

### CROSS-REFERENCE TO RELATED PATENT APPLICATION

This application is a continuation of international application number PCT/EP2021/071012 filed on Jul. 27, 2021 and claims the benefit of U.S. application No. 63/058,396 filed on Jul. 29, 2020.

This patent application relates to the subject matter disclosed in and claims the benefit of international application PCT/EP2021/071012 filed Jul. 27, 2021, and U.S. application No. 63/058,396, filed Jul. 29, 2020, the teachings and disclosure of which are hereby incorporated in their entirety by reference thereto for all purposes.

### BACKGROUND OF THE INVENTION

The invention relates to a functional element, which is in particular a flat gasket. For example, the functional element is provided for a fluid control component and is in particular provided for a motor vehicle component.

The invention further relates to a component comprising a functional element and a motor vehicle comprising a functional element and/or a component.

The invention further relates to a method for producing a functional element as mentioned above.

Further the invention relates to a method for producing a component and/or a motor vehicle.

It is an object of the invention to provide an improved functional element and/or improved component and/or an improved motor vehicle and/or an improved method producing the same.

### SUMMARY OF THE INVENTION

This object is solved according to one aspect of the invention by a functional element which comprises a functional layer with at least one filter portion, a covering part on each side of the functional layer, at least one fluid passage in the functional element which passes through a passage area of the at least one filter portion, and a sealing segment which surrounds the passage area in a circumferentially closed manner with sealing material of the sealing segment permeating the filter portion to provide a seal in the filter portion and which seals between the covering parts and the filter portion.

One advantage of the solution can be seen in the fact, that the functional element has a filter portion in its functional layer and therefore contaminants and pollutants which might be in a working fluid flowing in the fluid passage are hindered to pass through the filter portion of the functional layer.

Thereby, adversely effects of the contaminants or pollutants are at least reduced.

This is in particular advantageous in order to prevent failures due to the contaminants and pollutants further downstream of the fluid passage where otherwise the contaminants or pollutants could harm control elements, such as valves and/or sliders, or could block a portion of a fluid passage further downstream.

In particular an advantage of the present solution is, that the sealing material permeates the filter portion around the passage area and therefore the sealing segment seals the filter portion cross-sectionally and the working fluid passing through the fluid passage is directed through the filter portion, in particular from a passage in one of the covering parts to a passage in the other of the covering parts, and the sealing segment prevents spreading of the working fluid along the filter portion and the functional layer between the covering parts.

In particular, the sealing segment surrounds the passage area transverse to a direction of fluid flow through the fluid passage.

Preferably, the sealing segment provides a cross-sectionally seal in the filter portion. In particular the sealing segment prevents a working fluid from spreading transverse to its intended flow direction through the filter portion.

The working fluid is in particular a liquid, preferably a hydraulic medium, for example an oil.

Further details with respect to the sealing material have not been given so far.

In preferred embodiments the sealing material is an additional material arranged on at least one of the covering parts. In particular the additional sealing material is arranged on both covering parts. An advantage thereof is that for example the additional sealing material is sealingly attached to the covering part and protrudes from the covering part to permeate the filter portion and thereby seals in between the filter portion and the covering part and seals within the filter portion.

In particular, the additional sealing material is arranged on a surface of a side of the covering part facing towards the functional layer.

Different kinds of sealing materials, in particular pure materials or compositions of different materials, can be used.

In particularly preferred embodiments, the sealing material comprises a matrix material and a filler material.

Advantageously, the matrix material provides a fluid impermeable structure for providing the fluid impermeable seal and with the filler material properties of the sealing material can be specifically improved, for example the stability of the sealing segment can be enhanced and/or the filler material can provide for enhancing the volume of the sealing material in order to have sufficient extent for sealingly closing gaps in the filter portion.

For example, with the matrix material and the filler material a sufficiently high extent of the sealing segment can be provided for sealing between the covering parts with the filter portion in between.

In particular, the sealing material, in particular its matrix material, comprises an elastomer.

For example the sealing material, in particular its matrix material, is a rubber based material, which is in particular at least approximately a pure rubber or comprises at least to a large extent a rubber, in particular at least half of its weight fraction, preferably at least three quarter of its weight fraction, is a rubber.

Advantageously, the elastomer of the sealing material is a cured elastomer, in particular a vulcanized elastomer, in particular providing a more stable sealing material for a more reliable seal.

In particular, a curing temperature, for example a vulcanisation temperature, of the elastomer is at least approximately higher than 100° Celsius, preferably higher than 150° Celsius and/or smaller than 300° Celsius, for example smaller than 250° Celsius.

In certain preferred embodiments, the sealing material, in particular its matrix material, comprises fluorine.

For example, the elastomer is a fluorinated elastomer.

Advantageous embodiments provide that the sealing material comprises a blowing agent, in particular comprises a blowing agent as its filler material. In particular, thereby a volume of the sealing segment can be enhanced due to the blowing agent for reliably sealing between the covering part and the filter portion and in particular for permeating into the filter portion for properly sealing within the filter portion.

In particular, the sealing material, in particular the blowing agent, comprises an expanding material, which preferably upon proper treatment expands and thereby increases the volume of the sealing material and therefore the volume of the sealing segment.

For example, the proper treatment can be a chemical treatment and/or a physical treatment.

Preferably, the expanding material exhibits a phase transition temperature, in particular from a liquid state to a gaseous state. Accordingly, upon heating as a proper treatment this expanding material expands due to the transition from the liquid to the gaseous state.

Preferably, the phase transition temperature is lower than a curing temperature of the matrix material, such that when the matrix material is cured upon heating the expanding material is in its expanded state and therefore the matrix material is cured when the expanding material and therefore the sealing material is in an expanded state.

For example, for some embodiment the phase transition temperature of the expanding material is smaller than 150° Celsius.

In particular, the phase transition temperature is higher than 20° Celsius.

In some embodiments, the phase transition temperature is at least approximately within a range between 80° Celsius and 140° Celsius.

In other preferred embodiments the phase transition temperature of the expanding material is at least approximately within the range of between 20° Celsius and 80° Celsius.

In another embodiments the phase transition temperature is at least approximately within the range between 50° Celsius and 100° Celsius.

For example, the expanding material comprises or is an alkane.

In some preferred embodiments the sealing material, in particular its filler material, comprises particles, in particular particles formed by a thermoplastic.

For example, the particle provide stability to the sealing segment.

In certain embodiments, the particles are compact particles.

In other preferred embodiments, the particles are hollow particles which in particular encapsulate the expanding material. In particular, the hollow particles comprise a shell, which is preferably made of a thermoplastic, and the shell surrounds an interior in which the expanding material is located.

In particular, the shell of the hollow particles is elastic and therefore expands together with the expanding material while still surrounding and holding the expanding material in its expanded state. An advantage thereof is for example, that also in the expanded state the expanding material is kept within the sealing material and therefor within the sealing segment although it is in its expanded state volatile.

With respect to the arrangement of the sealing material, its components and the sealing segments no further details have been given so far.

Preferably, the filler material in particular the blowing agent, occupies within the sealing segment single blowing regions.

In particular, the blowing regions are a plurality of single blowing regions which are separated to each other and scattered within the sealing segment.

In particular, each blowing region has an extent which is smaller than the extent of the sealing segment, in particular an extent which is smaller than a height of the sealing segment.

For example, at least approximately each blowing region has a typical extent of at least one micrometer, preferably of at least five micrometers, for example of at least ten micrometers.

Advantageously, each of the blowing regions has a typical extent of less than 150 micrometers, in particular of less than 100 micrometers.

In some preferred embodiments, the typical extent of each blowing region is for example less than 80 micrometers.

In some other advantageous embodiments the typical extent of each blowing region is for example less than 50 micrometers, in particular less than 30 micrometers.

Advantageous embodiments provide that the matrix material forms a continuous matrix structure which is in particular a foam like matrix structure. Preferably, the matrix structure surrounds and in particular separates regions which comprise the filler material.

In particular, thereby a fluid impermeable sealing segment is formed by the continuous matrix structure which is in particular stabilized and expanded by the blowing regions with the filler material.

In certain embodiments the sealing material has been provided to both covering parts forming on each covering part a respective structure and when the functional element is assembled the respective structures contact each other, in particular are pressed against each other, forming an interface which is also fluid impermeable sealed and thereby forming a single fluid impermeable sealing structure throughout the entire sealing segment, in particular from one covering part through the filter portion to the other covering part.

In certain embodiments, the sealing material is attached arealy on at least one covering part.

In other preferred embodiments regions between single sealing segments are free of sealing material with the sealing segment surrounding respective fluid passages.

For example, thereby sealing material is saved and a sealing force is concentrated to apply around the fluid passages, wherein necessary.

Preferably, the sealing material is arranged to form a sealing line around the passage area.

In particular, on the at least one covering part, in particular on both covering parts, the sealing material is arranged along a plurality of sealing lines, which each surround a respective fluid passage.

In particular, one advantage thereof is that sealing lines provide reliable sealing segments.

Preferably, a width of a sealing line is several times larger, advantageously at least five times larger, for example at least ten times larger, than a typical extent of through openings of the filter portion. In particular, thereby it is provided that several neighbouring through openings of the filter portion are permeated by the sealing material to form a reliable seal.

For example, a width of a sealing line is less than fifty times larger than, for example less than thirty times larger than, a typical extent of the through openings of the filter portion.

The width of the sealing line is in particular measured from an inner side of the sealing segment which bounds the fluid passage to an outer side of the sealing segment opposite to the inner side.

For example, the width of the sealing line is measured in a direction within a geometrical plane of the filter portion in which the filter portion essentially extents and at least approximately perpendicular to a direction of fluid flow through the fluid passage.

The sealing line runs in particular along a contour line with the contour line enclosing the passage area in a circumferentially closed manner and in particular the width of the sealing line is measured at least approximately perpendicular to the contour line.

In particular, the respective breakthroughs in the covering parts corresponding to the fluid passage open at an opening at an inner side of the covering part which faces towards the functional layer.

In some embodiments, the sealing material is provided essentially directly at the opening and surrounding the same for directly sealing there the fluid passage.

In other preferred embodiments, the sealing material is provided to the at least one covering part in a distance to the opening.

For example with having the sealing material spaced to the openings, tolerances in processing in the sealing segment can be larger and therefore the production of the same is easier and less costly.

Another advantage can be seen in the fact, that the sealing material is not directly exposed to a flow of fluid through the fluid passage and therefore the risk of abrasion of sealing material and associated contamination of the working fluid is at least reduced.

For example, the distance of the sealing material to the opening is at least 0,05 millimeter, preferably at least 0,1 millimeter, for example at least 0,3 millimeter. In particular, the distance of the sealing material to a respective opening is smaller than 10 millimeter, in particular smaller than 5 millimeter, for example smaller than 2 millimeter. For example, the distance is at least approximately 0,5 millimeter.

In certain embodiments the distance of the sealing material to the opening is larger than one twentieth of the width of the sealing line, preferably larger than one tenth of the width. For example, the distance of the sealing material to the opening is smaller than the width of the sealing line, in particular smaller than two third of the width, for example smaller than one half of the width of the sealing line. For example in some embodiments the distance is at least approximately one fifth of the width of the sealing line.

A height with which the sealing material is provided onto at least one of the covering parts, in particular on both covering parts, is at least one fifth of the thickness of the filter portion, for example at least one third of the filter portion. In particular, it has turned out that these heights, which are in particular less than half of the thickness of the filter portion, are sufficient for efficiently permeating the filter portion and providing a reliable seal, in particular when the sealing material is provided to both covering parts.

For example, the height of the sealing material provided to one of the covering parts is less than the thickness of the filter portion, in particular if sealing material is also provided to the other covering part, to save sealing material and for providing a flat functional element. In particular a too high sealing segment could adversely affect efficiently pressing the two covering parts with a functional layer in between together.

Preferably, the height of the sealing material provided onto at least one of the covering parts, in particular on both covering parts, is at least approximately 10 micrometers, for example at least 20 micrometers.

In particular, the height of the sealing material provided onto at least one of the covering parts, in particular on both covering parts, is at least approximately smaller than 100 micrometers, for example smaller than 70 micrometers.

In preferred embodiments, sealing material is attached by screen printing to the covering part.

It is advantageous, when the sealing material attached to both covering parts is attached to these in a corresponding manner, such that sections of sealing material on both covering parts face each other.

In particular, in any case the sealing material is provided throughout the sealing segment from one inner side of one of the two covering parts to the inner side of the other of the two covering parts and permeating in between the filter portion such that the sealing material seals in between the covering parts and the filter portion and cross-sectionally in the filter portion.

Advantageously, a pressure is provided to the covering parts and transmitted to the sealing segment such that in particular a fluid impermeable seal between the covering parts and the filter portion and within the filter portion is formed.

In some embodiments, the sealing segment does not seal fluid-tight unless a pressure applied to it for permeating the filter portion and forming a fluid impermeable seal.

In particular, in an assembled state, mating parts are pressed together with the functional element in between for providing pressure on the sealing segment to form the fluid impermeable seal.

With respect to the filter portion no further details have been given so far.

In some embodiments the filter portion is made from plastic.

In other advantageous embodiments, the filter portion is made from a metal, for example made from steel, in particular stainless steel.

In particular, the filter portion is built by a plurality of wires and gaps in between the wires from through openings for a working fluid.

In particular, the wires extend along a direction of longitudinal extension and have a diameter transverse to the direction of longitudinal extension which is much smaller than the extension in the direction of longitudinal extension.

In particular, the wires extend in their direction of longitudinal extension throughout the filter portion.

For example, the wires have a diameter, which is in particular measured at least approximately perpendicular to their direction of longitudinal extension, which is smaller than 200 micrometer, in particular smaller than 100 micrometer and/or which is larger than 1 micrometer, preferably larger than 10 micrometer. In particular, the diameter is at least approximately within a range in between 40 micrometer and 60 micrometer.

Advantageously, the wires are calendared, in particular for providing stability to the filter portion and for reducing the height of the filter portion.

A thickness of the filter portion is in particular larger than 50 micrometer and/or smaller than 200 micrometer, in particular smaller than 150 micrometer.

In particular, the thickness of the filter portion is at least approximately at most equal to two times the diameter of the wires, preferably less.

The thickness of the filter portion is in particular measured at least approximately perpendicular to a geometrical functional plane within which the functional layer essentially extends.

In particular, the wires run at least approximately with their longitudinal extensions within the geometrical functional plane.

The gaps in between the wires have in particular a typical extension which is larger than 50 micrometer, for example larger than 100 micrometer, and/or which is smaller than 350 micrometers, in particular smaller than 250 micrometers. For example, the typical extension of the gaps is at least approximately within the range of in between 125 micrometers and 175 micrometers.

For example, the filter portion has an open area of at least approximately more than 40% and/or of at least approximately less than 80%. In some advantageous embodiments the open area mounts for at least approximately 60%.

In particular, there is a first group of wires and a second group of wires with the wires of the first group being arranged transverse to the wires of the second group, in particular the directions of longitudinal extension of the wires of the first group run at least approximately perpendicular to the direction of longitudinal extension of the wires of the second group. Advantageously, within one group the wires run at least approximately parallel to each other.

In particular, the gaps of the filter portion are formed between neighbouring wires of the first group and neighbouring wires of the second group.

In some embodiments, the filter portion is embedded in another part of the functional layer. For example, thereby the other part of the layer can be designed for providing other specific functions to the functional layer and/or to provide particular stability to the functional layer.

Other advantageous embodiments provide that, the functional layer comprises a mesh which extents essentially throughout the whole functional layer and for example essentially builds up the functional layer. The mesh provides one filter portion or several filter portions.

For example, this is a cost efficient and easily to design solution for the functional layer.

With respect to the covering parts no further details have been given so far.

In some embodiments, at least one of the covering parts is for example a part of a functional component to which the functional element is attached.

In other preferred embodiments, at least one of the covering parts is a covering layer, which is in particular attached to one of the sides of the functional layer.

Advantageously, both covering parts are a covering layer.

In particular, therewith a stable functional element is provided.

For example, the covering layer protects and seals parts of the functional layer and provides breakthroughs for respective fluid passages.

In particular, the covering layer is a flat layer.

For example, a thickness of the covering layer is at least approximately larger than 0,1 millimeters, preferably larger than 0,2 millimeters. For example, the covering layer has a thickness which is at least approximately smaller than 2,5 millimeters, preferably smaller than 1,4 millimeters. In some advantageous embodiments the covering layer has a thickness of at least approximately 0,8 millimeters.

The thickness of the layer is measured in particular at least approximately perpendicular to a geometrical layer plane in which the layer essentially extents.

The covering parts can be made of different materials.

In preferred embodiments, at least one of the covering parts, in particular both covering parts, are made of a metal.

Preferably, the covering layer of at least one covering part, in particular of both covering parts, is a metal layer.

Different kinds of metals can be used for different purposes.

It is particular advantageous, when the metal of the covering part is the same as the metal of a mating part to which the covering part is assembled to.

In some embodiments the metal of the covering part is a steel.

Advantageous embodiments provide, that at least one covering part, in particular both covering parts, comprise aluminium, in particular are made of aluminium.

For example, this provides a stable and light functional element. In particular, often the functional element is assembled to mating parts which are made of aluminium.

In particular, having the covering part, in particular the covering layer, being made from the same material as a mating part has the advantage, that during operation and the accompanying heating the functional element and the mating parts expand in at least a similar manner due to the same heating coefficient of the same material and therefore stresses and deformation can be reduced.

In preferred embodiments, an inner side facing towards the functional layer of at least one covering part, in particular the respective inner side of both covering parts, has a flat surface for an easy assembly with the functional layer.

Some advantageous embodiments provide that an outer side of the functional element which is opposite to the inner side facing towards the functional layer has a flat surface, which in particular runs at least approximately parallel to the surface of the inner side.

In particular, the respective outer side on each side of the functional element has a flat surface.

Preferably, at least one covering part, in particular both covering parts, are layers having flat surfaces on their inner and opposite side.

Having the flat opposite side provides in particular the advantage, that the functional element can be easily assembled between the mating parts.

For example, for flat gaskets the flat outer sides are advantageous.

In particular the respective covering part provides an outer side of the functional element, with in particular the outer side being the side opposite to the side facing toward the functional layer.

In particular preferred embodiments, at least one outer side of the functional element is provided with at least one sealing element for sealing with a mating part.

Preferably, both outer sides of the functional element are provided with at least one sealing element for sealing with a respective mating part.

In particular, therewith the functional element is able to be sealingly assembled to the mating parts and preferably the fluid passages of the functional element can be connected to corresponding fluid passages in the mating parts and the connections can be sealed by the one sealing element or by the several sealing elements.

Preferably, the at least one sealing element on the outer side is formed as a line to provide a sealing line on this outer side.

For example, having the one sealing element or several sealing elements being provided as sealing lines, sealing material can be saved and in particular reliable seals can be provided as a sealing force is concentrated to the sealing lines.

In particular, the one sealing element or the several sealing elements on the outer side correspond to to be sealed fluid passages and structures of the respective mating parts.

Preferably, openings in the outer side, which correspond to fluid passages through the functional element, are at least partly surrounded by a respective sealing element. Therewith, in particular the fluid passage can be sealingly connected to a corresponding fluid passage in the respective mating part.

Advantageously, opposite to a sealing segment provided at the inner side, at the outer side at least partly a sealing element, in particular formed as a sealing line, is provided.

Advantageously, providing the opening with a sealing element, in particular an elongated sealing line, provides for a good connection to the mating part and preferably a force with which the mating part is pressed to the functional element is transferred to the inner side and provides a sealing pressure to a respective sealing segment.

The sealing elements on the outer side can be built in several different ways.

Preferably, the sealing elements are made of an additional sealing material attached on the outer side.

For example, the additional sealing material is provided by screen-printing on the outer side.

In some preferred embodiments, the sealing material provided on the outer side is similar to the sealing material provided to the inner side and therefore it is fully referred to the explanations concerning the sealing material given above.

Preferably, the sealing material provided to the outer side is a rubber based sealing material, in particular as described above.

In some embodiments, the sealing material provided to the outer side comprises a blowing agent, for example as explained above.

In other advantageous embodiments, the sealing material provided to the outer side does not comprise a blowing agent, as the sealing material has to seal between the outer side and a mating part, which in particular are provided with flat sealing surfaces and no filter portion in between, such that an expansion of the sealing material is not necessary.

In particular, the covering parts are connected to each other for example by form fit and/or they are firmly bonded together.

In some preferred embodiments, the covering parts are connected to each other by clinching.

In some embodiments, the functional layer is adhesively connected to the covering parts.

In other preferred embodiments, the functional element is arranged between the two covering parts and clamped in between the two covering parts and in particular held due to the clamping. For example, thereby no additional adhesive or connection material is needed.

The object of the invention is in some embodiments solved by a component for a motor vehicle, which comprises a functional element which has one or several features as mentioned above.

In some embodiments the object of the invention is solved by a fluid controlled component which comprises a functional element with one or several features as mentioned above.

In particular, the fluid controlled component is a component for a motor vehicle.

In particular, the advantages provided above in connection with the respective features translate to the component.

In particular, the component comprises at least two control bodies with channels in respective channel sides, which face a respective outer side of the functional element and sealing elements are provided which seal in between the functional element and the respective control body.

In particular, the channel side of each control body abuts a respective outer side of the functional element, in particular an opposite side of a respective covering part, which is opposite to the inner side facing towards the functional layer.

Preferably, the sealing element between the functional element and the respective control body is a sealing element as described above and in particular provided to the outer side.

For example, the functional element is a flat gasket for the component.

In preferred embodiments, the component is at least a part of a transmission unit.

The object of the invention is also solved in some embodiments by a motor vehicle which comprises a functional element and/or a component with a functional element with the functional element and/or the component has one or several features as mentioned above.

The object of the invention is also solved by a method for producing a functional element. In particular the functional element is a flat gasket element and/or an element for a motor vehicle component and/or for a fluid control component.

Preferably, with the method a functional element is produced which has one or several features described above in connection with the functional element and for these features it is fully referred to the explanations given above and advantageously the method comprises one or several steps corresponding to the respective feature, in particular providing that feature to the functional element.

The method according to the invention comprises in particular the following steps whereas the order of the steps is interchangeable as far as no specific order is given or absolutely technically necessary.

In particular, the method comprises providing a functional layer with at least one filter portion, a covering part for each side of the functional layer with each covering part having at least one breakthrough for at least one fluid passage, aligning the breakthroughs to a passage area of the at least one filter portion for providing at least one fluid passage in the functional element which passes through the passage area and providing a sealing segment which surrounds the passage area in a circumferentially closed manner and with sealing material of the sealing segment being provided to permeate the filter portion for providing a seal in the filter portion and between the covering parts and the filter portion.

Preferably, the sealing material is an additional material provided to at least one of the covering parts, in particular to both covering parts.

Preferably, the sealing material is attached to a side of the covering part which faces towards the functional layer.

Advantageously, the sealing material is provided to the at least one covering part, in particular to both covering parts, by screen-printing.

In particularly preferred embodiments, the sealing material is provided to the covering part along at least one contour to provide a sealing line. Preferably, the sealing line is designed in a manner as described above and the method comprises one or several steps for providing the respective features to the sealing segment arranged to be a sealing line.

In particular, the sealing material provided within the method is a sealing material as described above and therefore reference is made to the explanations given above.

In particular, the sealing material has one or several features as described above, in particular one or several features directed to the matrix material and/or the filler material and/or the elastomer.

For example, the method comprises the step of providing an initial composition of the sealing material to the covering part and in particular the method comprises the step of drying the initial composition, for example at a temperature which is lower than 150° Celsius and/or which is higher than 70° Celsius.

For example, the initial composition comprises a solvent and the sealing material from which the sealing segment is to be formed.

In particular, the initial composition reduces its volume during the drying process, in particular due to diminishing of the solvent. For example, the initial composition looses at least half of its volume during the drying process.

For example, the sealing material has after the drying process a height over the surface of the covering part which is at least approximately larger than 10 micrometer, preferably larger than 20 micrometer, and/or which is smaller than 100 micrometer, in particular smaller than 60 micrometer.

Preferably, the method comprises subjecting the sealing material to a curing process. Advantageously, thereby the sealing material is cured for providing a sealing segment which seals reliable and stable.

For example, during the curing process the elastomer of the sealing material vulcanizes.

Several curing processes can be made according to the invention.

In preferred embodiments, the curing of the sealing material is done by heating the sealing material.

Preferably, the sealing material is heated to a temperature which is larger than a curing temperature, in particular a vulcanization temperature, of a matrix material of the sealing material.

For example, the sealing material is heated to a temperature which is at least approximately larger than 120° Celsius, preferably larger than 180° Celsius and/or to a temperature which is smaller than 300° Celsius, in particular smaller than 250° Celsius.

In particular, the method comprises an expanding process of the sealing material, in particular of a blowing agent comprised by the sealing material.

In particular, during the expanding process the volume of the sealing material increases, in particular at least by a factor of 1,5. For example the volume increase to at least twice its volume, for example the volume increases at least approximately three to four times.

Several expanding processes can be used according to the invention.

In preferred embodiments of the method the expanding process is provided by heating the sealing material.

In particular, the sealing material is heated to a temperature above which the sealing material, in particular a filler material thereof, expands, for example heated above a phase transition temperature of an expanding material within the sealing material.

In particular, the expanding material is provided within hollow particles and therefore during the expansion process, in particular, heating process, the volatile expanding material does not disappear out of the sealing material such that it is still provided within the to be produced sealing segment.

Preferably, the sealing material, in particular its blowing agent, is first expanded by the expanding process and then the curing process, in particular of the matrix material, occurs.

For example, the expanding temperature is lower than the curing temperature and by heating up the sealing material in particular its blowing agent, first expands and by further increasing the heat the sealing material, in particular its matrix material, cures while the blowing agent is in its expanded state.

In particular, after the heating process the sealing material is cooled down, in particular to a normal temperature, for example to room temperature.

In some advantageous embodiments the sealing material is provided onto at least one covering part and the functional layer is aligned to the covering part and then the expanding process and/or curing process is performed. For example, an advantage thereof is that during the expansion process the sealing material permeates into the filter portion.

In other preferred embodiments, the sealing material is provided onto the at least one covering part, in particular onto both covering parts, and then the curing process and/or expanding process are performed and thereafter the covering part is aligned with the functional layer. In particular, this provides an efficient and cost saving method.

In particular, the method comprises aligning the covering parts with the functional layer being in between and assembling the covering parts with the functional layer.

For example, the alignment of the covering parts and of the functional layer is provided to get a sealing segment around the passage area of the filter portion as described above in connection with the functional element to which reference is made and preferably the method comprises corresponding steps.

In particular, the method comprises the step of clamping the functional layer in between the covering parts.

In particular, the method comprises connecting the covering parts together, for example as explained above in connection with the functional element and reference is made thereto and preferably the method comprises one or several corresponding steps.

Preferably, the method comprises the step of finishing the functional element.

For example, the finished functional element is ready to be assembled in a component for example as described above.

The object of the invention is also solved by a method for producing a component. For example, the component is a component as described above, in particular a component for a motor vehicle and/or a fluid controlled component.

Thereby, the method comprises the step of providing a functional element and producing the same with one or several steps as described above.

In particular, the method for producing a component comprises the step of providing at least two control bodies and arranging the functional element with one or several features as described above in between the at least two control bodies.

In particular the two control bodies have fluid channels in respective channel sides and the method comprises assembling the control bodies such that the channel side of each control body faces towards a respective outer side of the functional element.

Preferably, the method comprises the step to align the control bodies and the functional element such that the channel side of each control body abuts a respective outer side of the functional element.

In particular, the method comprises providing at least one sealing element, in particular to each outer side of the functional element, for sealing in between the functional element and the respective control body.

In particular, the sealing element is formed of additional sealing material provided onto the outer side.

With respect to the sealing element reference is made to the explanations in connections with the component given above and in particular the method comprises at least one step for providing the sealing element with one or several features as described above.

Preferably, the method comprises finishing the component, for example to make it ready for assembly into a motor vehicle.

The object of the invention is also solved by method for producing a motor vehicle comprising the step of providing a functional element and/or a component as described above with at least one, preferably several steps as described above.

For example, the method is part of the production of a motor vehicle.

Preferably, the method comprises the step of finishing the motor vehicle.

Before and in the following the term “at least approximately” in connection with a feature, in particular a value or a direction, is to be understood in particular that technically conditioned and/or technically irrelevant variations to the feature, in particular to the value, are also comprised. For example, variations to a given value of up to 30%, in particular up to 10%, for example up to 5%, are comprised by a value given at least approximately. In particular, variations to a given direction of up to 25 degrees, preferably of up to 15 degrees, for example of up to 5 degrees, are comprised by a direction given at least approximately.

Before and in the following the term typically in connection with a property is to be understood, the given information as the typical order of that property, for example an average of at least approximately most of the elements having this property.

In particular the present disclosure comprises embodiments of the invention with the following consecutively numbered combination of features:

1. Functional element (100), in particular flat gasket, in particular for a motor vehicle component (350), comprising a functional layer (112) with at least one filter portion (118), a covering part (114, 116) on each side of the functional layer (112), at least one fluid passage (216) in the functional element (100) which passes through a passage area (232) of the at least one filter portion (118), and a sealing segment (252) which surrounds the passage area (232) in a circumferentially closed manner with sealing material (254) of the sealing segment (252) permeating the filter portion (118) to provide a seal in the filter portion (118) and between the covering parts (114, 116) and the filter portion (118).

2. Functional element (100) according to embodiment 1, wherein the sealing material (254) is an additional material arranged on at least one of the covering parts (114, 116).

3. Functional element (100) according to one of the preceding embodiments, wherein the sealing material (254) comprises a matrix material (272) and a filler material (274).

4. Functional element (100) according to one of the preceding embodiments, wherein the sealing material (254), in particular its matrix material (272), comprises an elastomer, in particular a rubber.

5. Functional element (100) according to one of the preceding embodiments, wherein the sealing material (254), in particular its matrix material (272), comprises a cured elastomer, in particular a vulcanized elastomer.

6. Functional element (100) according to one of the preceding embodiments, wherein the sealing material (254), in particular its matrix material (272), comprises fluorine, in particular a fluorinated elastomer.

7. Functional element (100) according to one of the preceding embodiments, wherein the sealing material (254), comprises, in particular as its filler material (274), a blowing agent.

8. Functional element (100) according to the preceding embodiment wherein the blowing agent comprises an expanding material (284), in particular an alkane.

9. Functional element (100) according to the preceding embodiment, wherein the blowing agent comprises hollow particles (282) encapsulating the expanding material (274).

10. Functional element (100) according to one of the three preceding embodiments, wherein particles (282) of the blowing agent are made from a thermoplastic material.

11. Functional element (100) according to one of the four preceding embodiments, wherein the filler material (274), in particular the blowing agent, occupies within the sealing segment (252) single, in particular separated and scattered, blowing regions (276).

12. Functional element (100) according to one of embodiments 3 to 11, wherein the matrix material (272) forms a continuous structure (278), in particular a foam like matrix structure (278), which surrounds regions (276) which comprise the filler material (274).

13. Functional element (100) according to one of the preceding embodiments, wherein regions between single sealing segments (252) which are free of sealing material (254), the single sealing segments (252) surround respective fluid passages (212, 214).

14. Functional element (100) according to one of the preceding embodiments, wherein the sealing material (254) is arranged to form a sealing line (256) around the passage area (232).

15. Functional element (100) according to the preceding embodiment, wherein a width of the sealing line (256) is several times larger than a typical extend of through openings (126) for a working fluid of the filter portion (118).

16. Functional element (100) according to one of the preceding embodiments, wherein the sealing material (254) is provided to the at least one covering part (116, 118) in a distance (D) to an opening (242, 244) corresponding to the fluid passage (214) passing through the passage area (232) of the filter portion.

17. Functional element (100) according to one of the preceding embodiments, wherein the sealing material (254) is provided onto at least one of the covering parts (116, 118) with a height which is larger than 20 micrometer and/or which is smaller than 150 micrometer.

18. Functional element (100) according to one of the preceding embodiments wherein sealing material (254) is attached to both covering parts (116, 118) in a corresponding manner.

19. Functional element (100) according to one of the preceding embodiments, wherein the filter portion (118) is built by a plurality of wires (124) and wherein gaps (126) in between the wires (124) form through openings (126) for a working fluid.

20. Functional element (100) according to one of the preceding embodiments, wherein the functional layer (112) comprises a mesh (122) which extends essentially throughout the whole functional layer (112), and provides the at least one filter portion (118).

21. Functional element (100) according to one of the preceding embodiments, wherein the side (152, 154) facing towards the functional layer (112) of at least one covering part (114, 116), in particular the respective side (152, 154) facing towards the functional layer (112) of each covering part (114, 116), has a flat surface onto which the sealing material (254) is provided.

22. Functional element (100) according to one of the preceding embodiments, wherein at least one covering part (114, 116) is a flat, layer, in particular both covering parts (114, 116) are each a flat layer.

23. Functional element (100) according to one of the preceding embodiments, wherein at least one covering part (114, 116) is a metal layer, in particular both covering parts (114, 116) are each a metal layer.

24. Functional element (100) according to one of the preceding embodiments, wherein at least one outer side (156, 158) of the functional element (100) has a flat surface.

25. Functional element (100) according to one of the preceding embodiments, wherein at least one outer side (156, 158) of the functional element (100) is provided with at least one sealing element (292, 294) for sealing with a mating part.

26. Functional element (100) according to the preceding embodiment, wherein the at least one sealing element (292, 294) on the outer side (156, 158) is formed as a line to provide a sealing line on this outer side (156, 158).

27. Functional element (100) according to one of the preceding embodiments, wherein the two covering parts are connected to each other by clinching.

28. Component (350) for a motor vehicle comprising a functional element (100) according to one of the preceding embodiments.

29. Fluid controlled component (350) comprising at least two control bodies (352, 354) with fluid channels (362) in respective channel sides (356, 354), wherein a functional element (100) according to one of the preceding embodiments is arranged in between the at least two control bodies (352, 354) and the channel sides (356, 358) are facing towards respective outer sides (156, 158) of the functional element, in particular each channel side (356, 358) of a respective control body (352, 354) abuts a corresponding outer side (156, 158) of the functional element (100), and sealing elements (292, 294) are provided which seal between the functional element (100) and the respective control body (352, 354).

30. Component (350) according to one of the preceding embodiments wherein the component is at least part of a transmission unit.

31. Motor vehicle comprising a functional element (100) and/or a component (350) with a functional element (100) according to one of the preceding embodiments.

32. Method for producing a functional element (100), in particular for producing a functional element (100) according to one of the preceding embodiments, comprising the following steps: providing a functional layer (112) with at least one filter portion (118), a covering part (114, 116) for each side of the functional layer (112) with each covering part (114, 116) having at least one breakthrough (236, 238) for at least one fluid passage (214), aligning the breakthroughs (236, 238) to a passage area (232) of the at least one filter portion (118) for providing at least one fluid passage (214) in the functional element (100) which passes through the passage area (232), and providing a sealing segment (252) which surrounds the passage area (232) in a circumferentially closed manner with sealing material (254) of the sealing segment (252) provided to permeate the filter portion (118) for providing a seal in the filter portion (118) and between the covering parts (114, 116) and the filter portion (118).

33. Method according to the preceding embodiment, wherein the sealing material (254) is attached to a side (152, 154) of at least one of the covering parts (114, 116), in particular by screen printing.

34. Method according to one of the preceding embodiments directed to a method, wherein providing the sealing material (254) comprises providing the sealing material (254) along at least one contour (262) for providing at least one sealing line (256).

35. Method according to one of the preceding embodiments directed to a method, wherein the sealing material (254) is a sealing material (254) with one or several features according to the preceding embodiments directed to the functional element (100) and the sealing material (254), in particular the sealing material comprises an elastomer.

36. Method according to one of the preceding embodiments directed to a method, wherein providing the sealing material (254) comprises subjecting the sealing material (254) to a curing process, in particular by heating.

37. Method according to one of the preceding embodiments directed to a method, wherein providing the sealing material (254) and the sealing segment (252) comprises an expanding process of the sealing material (254), in particular by heating.

38. Method according to one of the preceding embodiments directed to a method, wherein providing the sealing material (254) and the sealing segment (252) comprises expanding the sealing material (254) and curing the sealing material (254) in an expanded state.

39. Method according to one of the preceding embodiments directed to a method, wherein providing the sealing segment (252) comprises aligning the coverings parts (114, 116) with respect to the functional layer (112) and pressing the covering parts (114, 116) with the functional layer (112) in between together for having the sealing material (254) permeating the filter portion (118) in the region of the sealing segment (252).

40. Method according to one of the preceding embodiments directed to a method, wherein producing the functional element (100) comprises finishing functional element (100).

41. Method for producing a component, in particular a component according to one of the preceding embodiments directed to a component (350), comprising providing a functional element (100) wherein providing the functional element (100) comprises one or several steps according to the method for producing a functional element (100) according to one of the preceding embodiments directed to a method for producing a functional element (100).

42. Method according to the preceding embodiment, comprising the steps of providing at least two control bodies (352, 354) which have fluid channels (362) at respective channel sides (356, 358) and aligning the at least two control bodies (352, 354) with the functional element (100) in between such that the channel sides (356, 358) face towards a respective outer side (156, 158) of the functional element (100) and providing sealing elements (292, 294) for sealing between the functional element (100) and the respective control body (352, 354).

43. Method for producing a motor vehicle comprising providing a functional element (100) and/or a component (350), wherein the method comprises one or several steps according to the method according to one of the preceding embodiments directed to a method.

Further preferred features and advantages of embodiments of the invention are the object of the following detailed specification and the enclosed drawings.

### BRIEF DESCRIPTION OF THE DRAWINGS

In the drawings:

FIG. 1 shows a perspective view of a functional element;

FIG. 2 shows an exploded view of the functional element;

FIG. 3 shows a cross section of a filter portion of a functional layer and covering parts designed as layers in an exploded view;

FIG. 4 shows a cross section of a sealing segment in a filter portion similar to the exploded view of FIG. 3;

FIG. 5 shows a schematic sketch of sealing material of the sealing segment;

FIG. 6 shows a block diagram for a method producing a functional element;

FIG. 7 shows an exploded view of a fluid controlled component with two control bodies and a functional element in between;

FIG. 8 shows an outer side of a covering part which faces towards a mating part and is provided with sealing elements along a line structure.

### DETAILED DESCRIPTION OF THE INVENTION

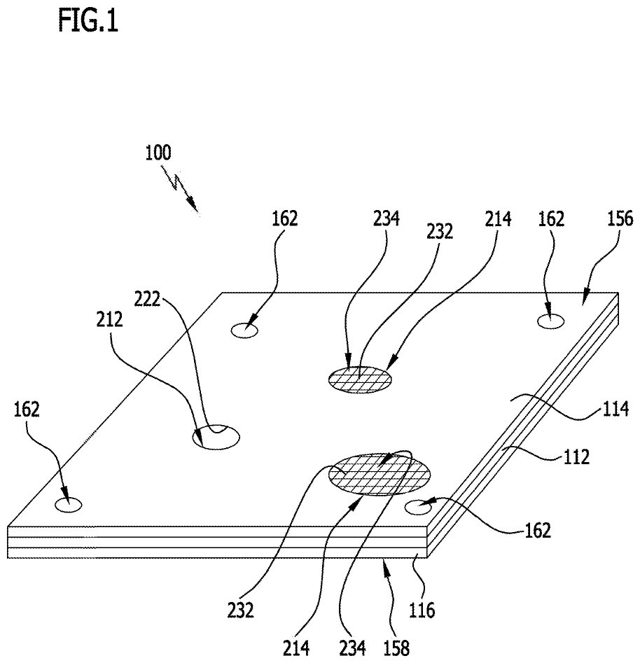

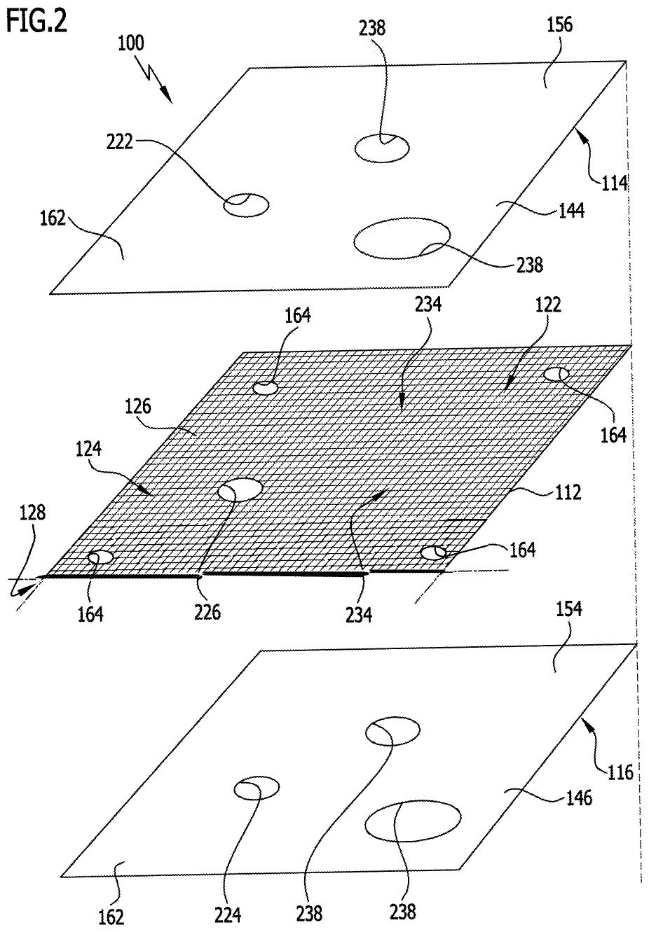

An embodiment of a functional element which is designated as a whole with 100 and shown exemplarily in FIGS. 1 to 5 comprises a functional layer 112 with at least one filter portion 118 and a covering part 114 and 116 on each side of the functional layer 112.

The functional layer 112 comprises a flat mesh 122 which provides several filter portions 118.

For example, mesh 122 essentially extends throughout the whole functional layer 112 and in particular builds up the functional layer 112.

The mesh 122 comprises a plurality of intersecting wires 124 with the wires 124 being arranged to provide gaps 126 which are sufficiently large to let a working fluid passing through but small enough to prevent contaminates passing through the mesh 122. Such contaminates are for example small particulates.

The working fluid is preferably a liquid in particular a hydraulic medium, for example an oil.

The mesh 122 extends essentially in a geometric functional plane 128 of functional layer 112 and the wires 124 run essentially in the functional plane 128 intersecting each other at least partly.

For example, the mesh 122 provides within the functional plane 128 an open area of at least approximately 60%, that is in particular in a projection of the mesh 122 onto the functional plane 128 the projection of gaps 126 covers at least approximately 60% of the functional plane 128 and the other at least approximately 40% are covered by the projection of the wires 124.

The wires 124 run essentially along a direction of longitudinal extension of themselves within the functional plane 128, however with a slightly up and down between crossings 132 with other wires. In particular at least approximately each of the wires 124 crosses other wires 124 and alternate by above and below the other wire at respective crossings 132.

Preferably, the mesh 122 is calendared, such that its height perpendicular to the functional plane 128 is less than twice the typical diameter of the wires 124 and in particular to provide a stability to the mesh 122.

The wires 124 extend elongated in a direction of longitudinal extension at least through one respective filter portion 118, preferably throughout the whole extend of the mesh 122. The wires have a much larger extend in the direction of longitudinal extension than transverse to this direction and have for example a typical diameter of at least approximately 50 micrometer in the direction transverse to the direction of longitudinal extension.

In particular the plurality of wires 124 comprises a first group of wires 124 and a second group of wires and the wires 124 are arranged such that the direction of longitudinal extension of the wires 124 of the one group runs obliquely, in particular at least approximately perpendicular, to the direction of longitudinal extension of the wires 124 of the other group and preferably the directions of longitudinal extension of wires 124 within one group run at least approximately parallel to each other.

Preferably, wires 124 of one group of the plurality of wires 124 are distanced to each other with a distance which is at least approximately in the range between 125 micrometers and 175 micrometers.

The gaps 126 are formed between neighboring wires 124 and have in particular a typical extend in the functional plane 128 within the range in between of at least approximately 125 micrometers to 175 micrometers.

The covering parts 114 and 116 comprise metallic layers 144 and 146 respectively which face each other with respective sides 152, 154, the surfaces of which are in particular essentially flat and run preferably at least approximately parallel to the functional plane 128.

The functional layer 112 with the mesh 122 extends in between the inner sides 152, 154 of the two covering parts 114 and 116 with the inner sides 152 and 154 facing towards the functional layer 112.

The layers 144, 146 have outer sides which are opposite to their respective inner side 152 and 154 and provide in this embodiment outer sides 156 and outer side 158 of the functional element 100 which are in particular opposite outer sides of the functional element 100.

In particular, the outer sides 156, 158 have flat surfaces which preferably run at least approximately within geometrical planes which run at least approximately parallel to the functional plane 128.

The covering parts 114, 116 and the functional layer 112 are fixed together at mounting spots 162.

Preferably, the covering layers 144 and 146 are clinched together with the mesh 122 having respective cutouts 164 at the mounting spots 162, such that the layers 144, 146 are clinched directly together and the functional layer 112 is in particular clamped in between.

The functional element 100 has several fluid passages 212, 214 for a working fluid which run through the covering layers 144, 146 and the functional layer 112 and in particular from one outer side 156 to the other outer side 158.

Some fluid passages 212 let the working fluid essentially unobstructed through by providing an essentially hollow passage through the functional element 100 without any interfering sections therein.

For these fluid passages 212 the covering layers 144 and 146 have breakthroughs 222, 224 extending from the respective inner side 152, 154 throughout the layer 144, 146 to the opposite side 156, 158 respectively. At these fluid passages 212 the functional layer 112 has a breakthrough 226 which is in this embodiment a cutoff in the mesh 122. In particular, the breakthroughs 222, 224, 226 are aligned with respect to each other to overlap and thereby providing the free fluid passage 212 for the working fluid.

Other fluid passages, here fluid passages 214, pass through a passage area 232 of respective filter portions 118 provided by the mesh 122.

Aligned with the respective filter portion 118 there are breakthroughs 236 and 238 in covering layers 144 and 146, respectively, which overlap with the passage area 232 such that the working fluid can flow through the fluid passage 214 from one side of the functional element to another side of the same by passing through one of the breakthroughs 236, 238, passing through the passage area 232 of filter portion 118 and passing the other one of breakthroughs 236, 238.

An extend of the fluid passage 214 transverse to the direction of flow of the working fluid through the passage 214, in particular an extend of the passage 214 at least approximately parallel to the functional plane 128, is much larger than the extend of the gaps 126, for example at least five times lager, in particular at least ten times larger than the typical extend of the gaps 126.

The breakthroughs 236, 238 open at respective openings 242, 244 in layers 144, 146 at their respective inner sides 152, 154. The openings 242, 244 face towards the functional layer 112 and overlap with the passage area 232 of the respective filter portion 118.

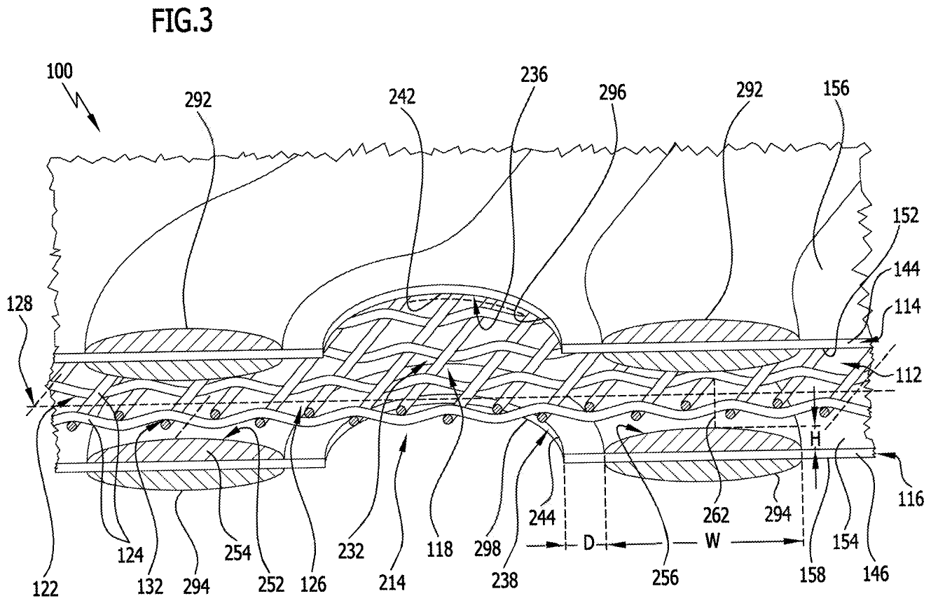

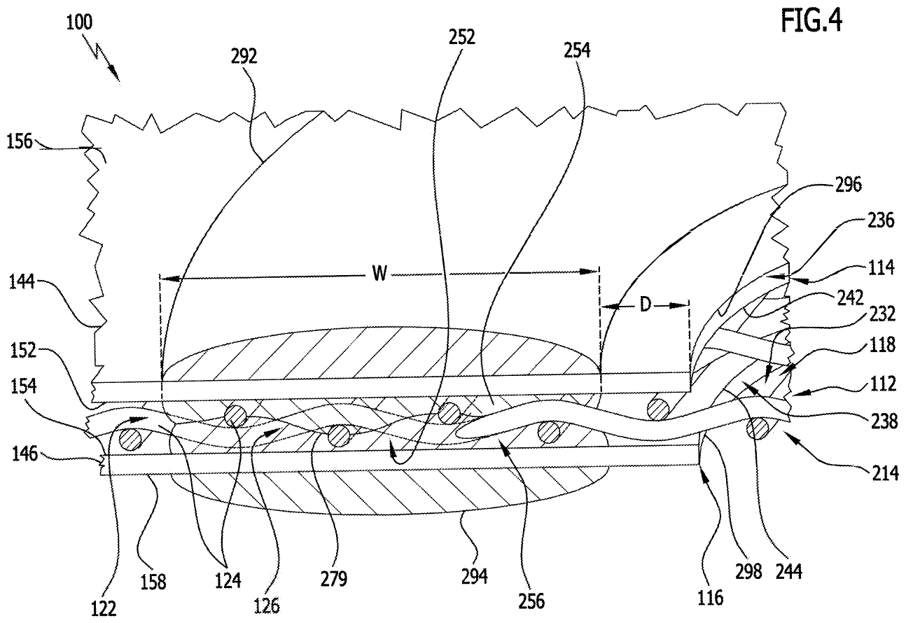

Around the passage area 232, there is a sealing segment 252 which surrounds the passage area 232 in a circumferentially closed manner, such that in particular with respect to the functional plane 128 the passage area 232 is fully enclosed by the sealing segment 252, as exemplarily shown in FIGS. 3 and 4.

Sealing material 254 is provided in the sealing segment 252 to inner sides 152, 154 of both covering layers 144, 146 around openings 242, 244 and the sealing material 254 elevates over the surface of inner sides 152, 154 and permeates the filter portion 118.

The sealing material 254 forms a fluid impermeable structure which extends from the inner side 152, 154 of one of the covering layers 144, 146 to the other inner side 154, 152 of the other covering layer 146, 144 thereby embedding the filter portion 234 in the sealing segment 252 and which fully encloses the fluid passage 214 in a direction transverse to the flow of the fluid.

Thereby the sealing material 254 seals the filter portion 118 in the sealing segment 252 cross-sectionally impermeable for the working fluid.

In particular, sealing segment 252 is provided as a sealing line 256 running along a contour 262 which surrounds the openings 242, 244 and the passage area 232 in a circumferentially closed manner and extending transverse with a width W which is several times larger than the typical extend of the gaps 126 and the typical diameter of wires 124 such that transverse to the direction of fluid flow several neighboring gaps 126 are closed by the sealing material 254. The width W of sealing line 256 is measured transverse, in particular at least approximately perpendicular, to the contour 262.

The sealing segment 252 is spaced from the apertures 242, 244 in the direction transverse, in particular, at least approximately perpendicular to the direction of fluid flow such that there is a clearance in between and the sealing material 254 is at least a distance D apart from the apertures 242 and 244 with the distance D being in particular at least 0.1 mm large and for example at least approximately 0.5 mm large.

The distance D is in particular measured from an edge of the respective aperture 242, 244 to the sealing material 254 in a direction transverse, in particular at least approximately perpendicular, to the direction of fluid flow through the fluid passage 214, in particular in a direction which runs at least approximately parallel to the functional plane 128 and which runs from the point of the edge of the aperture 242, 244 to the nearest located part of sealing material 254.

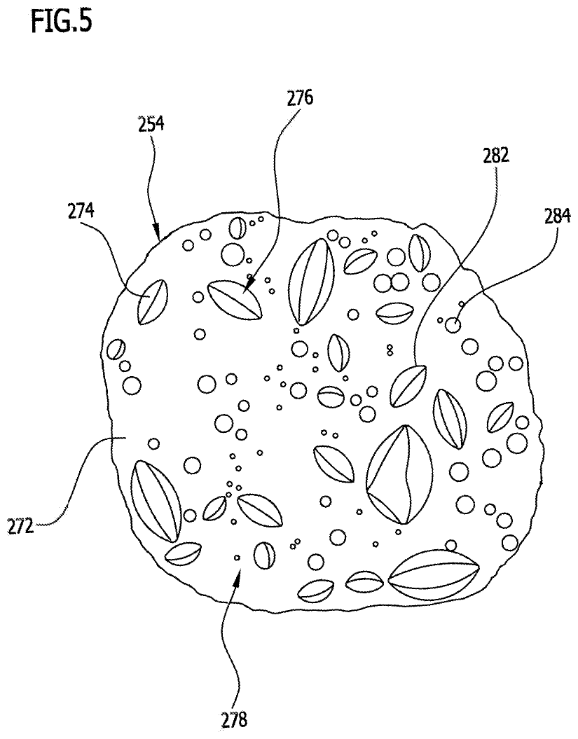

The sealing material 254 comprises a rubber based matrix material 272 and a filler material 274 with the filler material 274 occupying a plurality of individual, separated blowing regions 276 which are scattered around the sealing segment 252 and at least approximately each of the blowing regions 276 is fully enclosed by a matrix 278 formed from the matrix material 272, as exemplarily sketched in FIG. 5.

Accordingly, the matrix material 272 forms a matrix structure 278 which expands throughout the sealing segment 252 and in particular provides a fluid impermeable barrier structure from one inner side 152, 154 to the other inner side 154, 152 of the covering layers 144, 146 and continuously expanding surrounding around the passage area 232 in a circumferentially closed manner.

In particular, the sealing material 254 has been provided onto both inner sides 152, 154, for example as explained below.

Accordingly, there is in fact an interface 279 in the sealing segment 252 between the sealing materials 254 provided to either side of inner sides 152, 154.

However, as each part of the sealing segment 252 are arranged to be in sealing contact, in particular by pressing the two covering layers 144 and 146 together, no fluid can pass along the interface 279 and therefore the sealing materials 254 provided to either side of inner sides 152, 154, in particular their respective matrix structures 278 together, build nonetheless a fluid impermeable barrier.

The matrix material 272 is in particular an elastomer, for example a fluorinated elastomer, which has been cured by vulcanization.

Enclosed within the matrix material 272 is distributed in a plurality of single blowing regions 276 the filler material 274, which in particular provides stability to the sealing line 256 without disturbing the continuously closed barrier structure of the matrix material 272.

Preferably, the filler material 274 comprises hollow particles 282 which are filled with an expanding material 284, that is the particles 282 have a shell surrounding an interior in which the expanding material 284 is located. Preferably the shell of the particles 282 is made from a thermoplastic material.

Preferably, the particles 282 are adhesively connected to the matrix material 272 in addition to being surrounded by the same.

The expanding material 284 is in particular a solvent which has a boiling temperature which is smaller than the temperature at which the matrix material 272 vulcanizes, such that during the vulcanization of the matrix material 272 the expanding material 284 is in a gaseous state for expanding the sealing material 254.

For example the expanding material 284 is an alkane.

The sealing material 254 is provided to each of the covering layers 144 and 146 in particular by screen printing and curing the matrix material 272 thereafter.

The sealing material 254 provided on both covering layers 144, 146 at their respective inner sides 152, 154 is provided with a height H over the surface of the inner side 152, 154. For example, height H is at least larger than one fifth of the thickness of the mesh 122. In particular, the height H is measured in a direction at least approximately perpendicular to the surface of the inner side 152, 154 and at least approximately at the contour 262.

The respective sealing lines 256 at each inner side 152, 154 of the covering layers 144 and 146 run correspondingly to each other such that with assembling the functional element 100 the sealing lines 256 at each inner sides 152, 154 are aligned to each other and enclose a corresponding section of the filter portion 118 in the sealing segment 252 in between and permeating through the gaps 126 and sealingly attach to each other as well as sealingly enclosing the wires 124 and their crossings 132, such that the sealing segment 252 forms a cross-sectionally seal impermeable for the working fluid.

In particular, around the breakthrough 226 in mesh 122 for the free fluid passage 212 there is also provided a sealing segment comprising a sealing material for cross-sectional sealing of the fluid passage 212 in the area of the mesh.

Preferably, similar sealing lines as sealing lines 256 are provided around openings in inner sides 152 and 154 corresponding to the breakthroughs 222 and 224 in covering layers 144 and 146 and therefore reference is made to the description given above.

In particular, the outer sides 156 and 158 of the functional element 100 which are here the opposite sides to the inner sides 152, 154 of the covering layers 144, 156 are designed for assembling to and sealing with mating parts.

Therefore, on the outer sides 156, 158 sealing elements 292, 294 are provided to seal between the functional element 100 and the respective mating part, for example around openings 296 and 298 at the outer sides 156 and 158 of the respective breakthroughs 222 and 224 and/or at fluid channels of the mating part.

Preferably the sealing elements 292 and 294 are provided as sealing lines made of rubber based sealing material attached on the in particular flat surfaces of the outer sides 156, 158 for example by screen printing.

Advantageous sealing material and preferred provision of the sealing lines correspond essentially to the above given explanations, such that it is fully referred thereto. The sealing material of the outside sealing elements 292, 294 is preferably the same as the one for the inner sealing segment 252 but can be also a different sealing material or one that has only some components in common.

In particular, sealing elements 292, 294 run at least partly around the openings 296 and 298 in a manner corresponding to sealing lines 256 around openings 242 and 244.

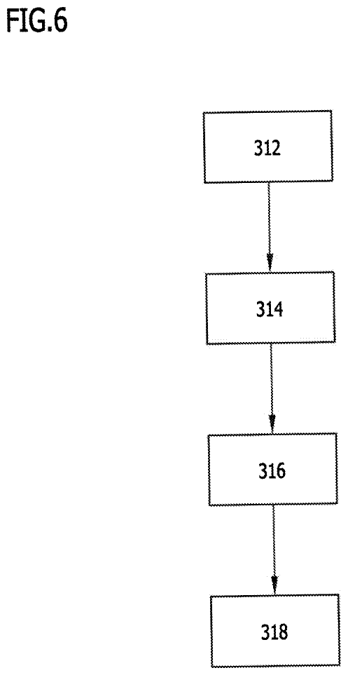

An exemplary method for producing an embodiment of a functional element 100 comprises in particular the following steps which are also sketched in FIG. 6.

At a step 312 covering layers 154 and 146 are provided as covering parts 114, 116 and the same are provided with breakthroughs 222 and 224 for fluid passages 212 and breakthroughs 236 and 238 for fluid passages 214.

In a following step 314 an initial composition of the sealing material 254 is provided, wherein the initial composition comprises the matrix material 272 and in the filler material 274 and a solvent such that the initial composition is capable to be provided along pre-defined line structures on the respective sides of layers 144 and 146, in particular by screen printing.

For example, the initial composition comprises more solvent than matrix material and filler material, for example the solvent accounts for at least approximately 60% of the initial composition.

The provided initial composition is then attached on the surfaces of the respective sides 152, 154 of the covering layers 144, 146 along the predefined line structure which comprise the areas for sealing segments 252. The attaching of the initial composition is preferably done by screen printing.

In particular, the regions in between the sealing lines on the surfaces of the sides 152, 154 are let vacant.

In particular, the initial composition is provided with a distance D apart from the openings 242 and 244 and from other openings, if applicable.

Thereafter, the initial composition is dried for example at a temperature less than 100° C. for release of the solvent such that essentially only the matrix material 272 and the filler material 274 remains on the surfaces. Accordingly, the amount of material along the line structures is diminished essentially during the drying process and for example after drying the sealing material 254 has along the line structures only a typical height of at least approximately within the range of 20 micrometer to 60 micrometers.

In the next step 316 the matrix material 272 is cured and the filler material 274 which comprises the hollow particles 282 encapsulating the expanding material 284 is expanded. Therefore, the sealing material 254 is heated at least to a curing temperature of the matrix material 272, in particular to temperatures above 100° C., for example up to temperatures larger than 180° C. and for example to temperatures of at least approximately 200° C.

In particular, the sealing material 254 is sufficiently heated such that at least the vulcanization temperature of the matrix material 272 is reached and the matrix material 272 vulcanizes. As a boiling temperature of the expanding material 284 is lower than the temperature to which the sealing material 254 is brought the expanding material 284 becomes gaseous and expands and with it the shell of the particles 282 expands. As the shell of the particles 282 expands with the expanding material 284 the latter is still enclosed by the shells and at least most of it does not disappear out of the to be formed sealing segment despite of being volatile.

In particular, in this step the particles 282 increase their size, for example their size increase at least by a factor of 1,5, preferably at least by a factor of 2.

During expansion, the filler material 274 stays surrounded by the matrix material 272, for example due to adhesion, and the whole sealing material 254 increases its volume. As the matrix material 272 maintains surrounding the particles 282 the continuously matrix structure 278 is formed and the matrix material is cured, in particular vulcanized, in this matrix structure 278 due to the heating process.

After the heating process the sealing material 254 returns to a normal temperature, for example room temperature, but due to the cured matrix material 272 the sealing material 254 remains at an enlarged state compared with the state before the heating process despite that the hollow particles 282 partially collapse due to the reduced volume of the expanding material 284 at the normal temperature. For example, a full collapse to the initial volume of the particles 282 is prevented by the cured matrix material 272 to which the shell of the particles 282 sticks adhesively.

In corresponding steps, the outer sides 156 and 158 are provided with sealing elements 292, 294, in particular formed by a similar sealing material as sealing material 254, in particular comprising the same or a similar material as matrix material 272 but without a filler material as this is not necessarily needed for providing sealing lines which reliably seal with the typically flat sealing surfaces of the mating parts.

In a further step 318 the mesh 122 as the functional layer 112 with the filter portions 118 is provided and the cutouts 164 for the mounting spots 162 and the breakthroughs 226 for the fluid passages 212 are cut.

Further in this step, the mesh 132 is arranged between the covering layers 144 and 146 with their inner sides 152 and 154 facing towards the mesh 122 and the filter portions 118 being aligned to the openings 242 and 244. If applicable, also other portions like the breakthroughs 226 or the cutouts 164 are aligned with corresponding openings of breakthroughs 222 and 224 and with the corresponding mounting spots 162, respectively.

Following of the arrangement the layers 144, 112, 146 are attached to each other, in particular by clinching at the mounting spots 162.

During attaching to each other, the layers 144 and 146 are brought at their inner sides 152 and 154 in contact with a respective sides of the mesh 122. Thereby the sealing lines 256 with the sealing material 254 are pressed into the mesh 122 in the area of the sealing segment 252 and close the gaps 126 and sealingly align to the wires 124 such that in the sealing segment 252 due to the permeating sealing material 254 a cross-sectionally seal surrounding the passage area 232 is formed.

The functional element 100 as described before is in particular designed as an element of a fluid control component designated as a whole with 350, for example as a flat seal or separator plate thereof with additional functionality due to the fluid passages 214 with filter portions 118.

In particular, the component 350 is a component for a motor vehicle and for example part of an automatic transmission unit.

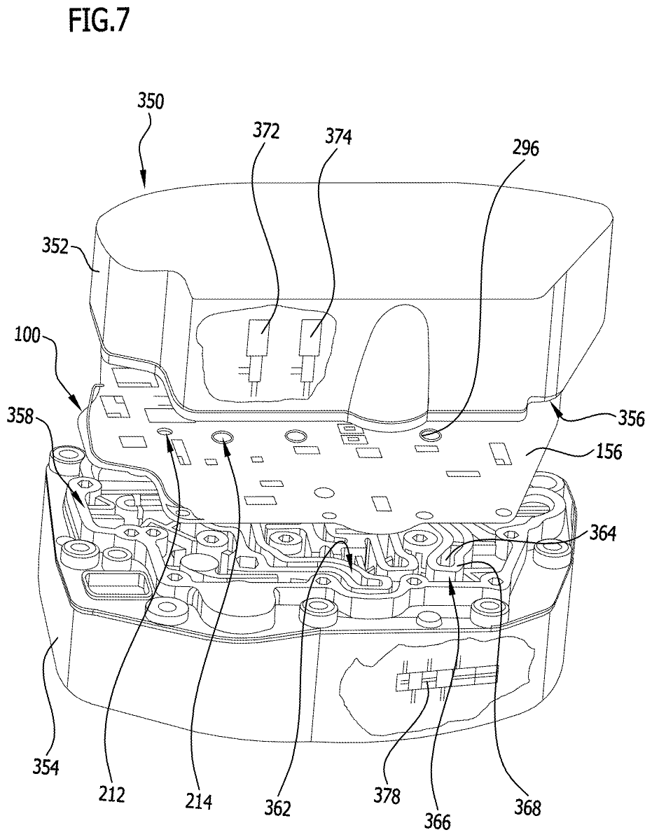

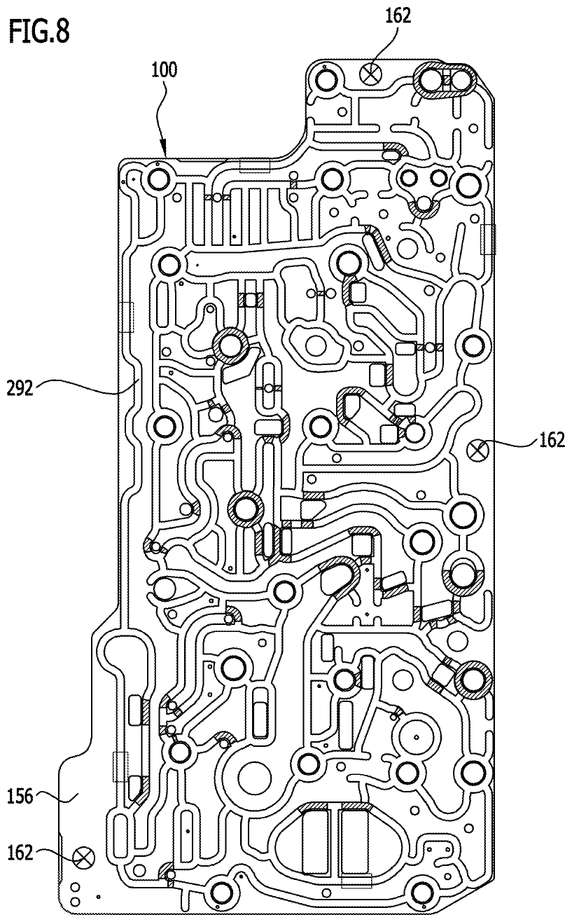

The fluid control component 350, exemplarily shown in FIGS. 7 and 8, comprises two control bodies 352 and 354 which face each other with respective sides 356, 358.

Fluid passages are provided in the respective bodies 352, 354 and from one body 352, 354 to the other body 354, 352.

For example, the bodies 352, 354 have channels 362 at their sides 356, 358 with corridors 364 allowing the working fluid to flow therein from one point at the side 356, 358 to another point at this side and the corridors 364 being bounded by channel walls 366 but open towards the respective side 356, 358.

In particular, the channel walls 366 extend along the corridors 364 and have upper end surfaces 368 facing towards the functional element 100 and the other body 354, 352. The upper end surfaces 368 of a respective body 352, 354 extend in particular at least approximately within one common geometrical surface plane of the respective side 356, 358.

The fluid passages within the fluid control component 350 are provided for operating control functions by having pressure differentials being submitted by the working fluid in the fluid passages and/or by a flow of the working fluid through the fluid passages.

In particular, there are several control elements in the fluid control component 350 for operating the control functions, for example valves 372, 374 and/or sliders 378 for providing, controlling and/or regulating the flow of the working fluid and/or pressure differentials therein.

The functional element 100 is provided in between the control bodies 352, 354, which are in this embodiment the mating parts mentioned above, for sealing the channels 362 at their open sides and to allow the working fluid to pass through the fluid passages 212, 214 in a defined manner from one control body 352, 354 to the other control body 354, 352.

For example, the openings 296, 298 at the outer sides 156 and 158 of the functional element 100 are aligned with respective points at the channels 362 for connecting on channel 362 at one control body 352, 354 to another channel 362 at the other control body 354, 352.

With the filter portion 118 in the fluid passages 214 contaminants and pollutants which might be in the working fluid are prevented to pass along the functional element 100 and to be distributed within the fluid passages of the fluid control component 350 and for example to harm other control elements, such as the valves 372, 374 and sliders 378 therein and/or to block channels 362 and to adversely affect the transmission of fluid flow and/or pressure differentials there through.

The outer sides 156 and 158 of the functional element 100 are assembled to the sides 356 and 358 of the control bodies 352, 354, respectively. The sealing elements 292, 294 are in sealing contact with the upper end surfaces 368 of the channel walls 366 when the fluid control component 350 is assembled to seal the channels 362.

Accordingly, the sealing elements 382 follow on the outer sides 156 and 158 respective line structures according to the fluid channels 362 of the respective control body 352, 354, as exemplarily shown in FIG. 8.

Preferably, the sealing elements 292, 294 are formed by rubber based additional sealing material put on the outer side 156, 158 for example by screen printing, as mentioned above.

Advantageously, the sealing material of the sealing elements 292, 294 has one or more features of the sealing material 254 described above and therefore it is fully referred to the explanations of sealing material 254 above.

Preferably, the sealing elements 292, 294, in particular the sealing lines with sealing material, are aligned on the outer sides 156, 158 at least essentially as described above in connection with the sealing lines 256 with one or more afore-mentioned features and therefore it is fully referred to the explanations given above in connection with the sealing segment 252, the sealing material 254 and the corresponding sealing lines 256.

In order to not interfere with the channel walls 366, the mounting spots 162 are preferably aligned within a corridor 364 or aligned at an area of the functional element 100, which is not in contact with the mating part, such as the bodies 352, 354, for example an area extending out of the assembled bodies 352, 354.

1. Functional element comprising a functional layer with at least one filter portion, a covering part on each side of the functional layer, at least one fluid passage in the functional element which passes through a passage area of the at least one filter portion, and a sealing segment which surrounds the passage area in a circumferentially closed manner with sealing material of the sealing segment permeating the filter portion to provide a seal in the filter portion and between the covering parts and the filter portion.

2. Functional element according to claim 1, wherein the functional element is a flat gasket.

3. Functional element according to claim 1, wherein the sealing material is an additional material arranged on at least one of the covering parts.

4. Functional element according to claim 1, wherein the sealing material comprises a matrix material and a filler material.

5. Functional element according to claim 1, wherein the sealing material comprises at least one of an elastomer and/or fluorine.

6. Functional element according to claim 4, wherein the matrix material comprises at least one of an elastomer and/or fluorine.

7. Functional element according to claim 1, wherein the sealing material comprises a blowing agent.

8. Functional element according to claim 7, wherein the blowing agent comprises hollow particles encapsulating an expanding material.

9. Functional element according to claim 4, wherein the filler material occupies within the sealing segment single, separated and scattered blowing regions.

10. Functional element according to claim 1, wherein regions between single sealing segments are free of sealing material.

11. Functional element according to claim 1, wherein the sealing material is arranged to form a sealing line around the passage area.

12. Functional element according to claim 1, wherein the sealing material is provided to the at least one covering part in a distance to an opening corresponding to the fluid passage passing through the passage area of the filter portion.

13. Functional element according to claim 1, wherein the functional layer comprises a mesh which extends essentially throughout the whole functional layer, and provides the at least one filter portion.

14. Functional element according to claim 1, wherein a side facing towards the functional layer of at least one covering part has a flat surface onto which the sealing material is provided.

15. Functional element according to claim 1, wherein at least one covering part is a flat layer.

16. Functional element according to claim 1, wherein at least one covering part is a metal layer.

17. Functional element according to claim 1, wherein at least one outer side of the functional element has a flat surface.

18. Functional element according to claim 1, wherein at least one outer side of the functional element is provided with at least one sealing element for sealing with a mating part.

19. Functional element according to claim 18, wherein the at least one sealing element on the outer side is formed as a line to provide a sealing line on this outer side.

20. Functional element according to claim 1, wherein the two covering parts are connected to each other by clinching.

21. Component for a motor vehicle comprising a functional element according to claim 1.

22. Fluid controlled component comprising at least two control bodies with fluid channels in respective channel sides, wherein a functional element according to claim 1 is arranged in between the at least two control bodies and the channel sides are facing towards respective outer sides of the functional element and sealing elements are provided which seal between the functional element and the respective control body.

23. Motor vehicle comprising a functional element according to claim 1.

24. Method for producing a functional element comprising the following steps: providing a functional layer with at least one filter portion, a covering part for each side of the functional layer with each covering part having at least one breakthrough for at least one fluid passage, aligning the breakthroughs to a passage area of the at least one filter portion for providing at least one fluid passage in the functional element which passes through the passage area, and providing a sealing segment which surrounds the passage area in a circumferentially closed manner with sealing material of the sealing segment provided to permeate the filter portion for providing a seal in the filter portion and between the covering parts and the filter portion.

25. Method according to claim 24, wherein the sealing material is attached to a side of at least one of the covering parts, in particular by screen printing.

26. Method according to claim 24 directed to a method, wherein providing the sealing material comprises subjecting the sealing material to a curing process.

27. Method according to claim 24 directed to a method, wherein providing the sealing material and the sealing segment comprises an expanding process of the sealing material.

28. Method according to claim 24 directed to a method, wherein providing the sealing material and the sealing segment comprises expanding the sealing material and curing the sealing material in an expanded state.

29. Method according to claim 24 directed to a method, wherein providing the sealing segment comprises aligning the coverings parts with respect to the functional layer and pressing the covering parts with the functional layer in between together for having the sealing material permeating the filter portion in the region of the sealing segment.
